(19) United States
(12) Patent Application Publication
(10) Pub. No.: US 2011/0260359 A1
(43) Pub. Date: Oct. 27, 2011

(54) COMPRESSION MOULD FOR COATING A MEMBER WITH A COATING LAYER

(75) Inventors: Nathalie Durand, Cergy (FR); Hugo Piccin, Paris (FR)

(73) Assignee: FAURECIA INTERIEUR INDUSTRIE, Nanterre (FR)

(21) Appl. No.: 12/937,203

(22) PCT Filed: Apr. 9, 2009
(86) PCT No.: PCT/FR2009/050637

§ 371 Date: Oct. 8, 2010

(30) Foreign Application Priority Data
Apr. 11, 2008 (FR) 0852447

(51) Int. Cl. B29C 41/38; B29C 63/48

(52) U.S. Cl. 264/269; 425/95

(57) ABSTRACT

The invention relates to a compression mould for coating a rigid member that includes a male portion and a female portion each including a reception surface, respectively, of the member and of a coating layer. The surface has the shape of the member, one of the portions being movable so as to bear against the member and the coating layer in order to bind the coating layer to the member. A silicone-based coating is attached to one of the portions, wherein the coating is intended to bear against the member in order to apply a substantially uniform pressure on said member.

The present disclosure relates to a compression mould for coating a rigid member with a coating layer, of the type comprising a male part and a female part each comprising a reception surface for respectively receiving said member and the coating layer, said surface having the shape of said member, one of the parts being movable so as to bear against the member and the coating layer in order to bind said coating layer to said member.

The disclosure also relates to a method for coating a rigid member by compression, by using such a compression mould.

Such rigid members are used i.a. for making trimming members, e.g. for motor vehicles, or as decorative coatings in a large number of applications.

Such rigid members, for example parts comprising natural fibres, are for example shaped by compression by means of a compression mould or by injection, with which it is possible to give the member the desired three-dimensional shape.

The member is then coated with a coating layer by means of a compression mould in which the three-dimensional member and a coating layer are placed and pressed against each other in order to bind the coating layer to the three-dimensional member.

However, certain members do not have sufficient dimensional stability so that the member does not deform after its making for example by compression or by injection. This is notably the case for parts comprising natural fibres

Thus, the geometry of the member is not constant and the member may for example deform because of its handling or climatic changes. When the member is positioned in the compression mould in order to carry out its coating, it may not be adjusted in a satisfactory way. This deformation is a nuisance upon coating by compression and may lead to poor coating of the member and to an unsatisfactory quality of the final member.

In order to overcome these drawbacks, the use of a thin foam layer on the back of the coating is known in order to fill the possible dimensional instabilities; indeed, the foam will be more or less crushed depending on the areas of deformations of the member, and the coating will always be properly applied on the member.

Such a foam layer is used in most applications for coating textiles on a rigid member, for example for creating trims of motor vehicle doors.

However, the foam layer gives the coated member a << soft >> touch which is not necessarily satisfactory for certain applications. Indeed, for some of these parts, it is desired to obtain a << hard >> touch.

One of the objects of the disclosure is to propose a solution for overcoming these drawbacks of dimensional instability by proposing a compression mould with which it is possible to do without a foam layer and obtain a satisfactory coating of said member.

For this purpose, the disclosure relates to a compression mould of the aforementioned type, wherein a resin-based coating is attached to one of the parts, said coating being intended to compensate for the geometrical instability of the member so as to apply a substantially uniform pressure on said member.

According to other features of the compression mould:

the male part is movable towards the female part, the resin-based coating being attached to said male part;

the compression mould comprises means for heating at least one of the parts of the mould in order to bind the coating layer to the member by thermocompression;

the resin-based coating has a hardness substantially comprised between 60 shore A and 100 shore A;

the resin-based coating is a polymer based on silicon or on polyurethane withstanding temperatures greater than or equal to 30° C.;

the resin-based coating withstands temperatures greater than or equal to 90° C.;

the resin-based coating has a thickness substantially comprised between 1 mm and 10 mm; and

the part to which the resin-based coating is attached comprises means for forming a vacuum on the reception surface of said part in order to retain the member against said part.

The disclosure also relates to a method for coating a rigid member by compression, using a compression mould as described above, this method comprising the following steps:

positioning a coating layer and the member, each on a reception surface of the mould,

moving the movable part of the mould so that the resin-based coating uniformly bears against the member and the coating layer and the other part and binds the coating layer to the member,

moving the movable part so as to move it away from the other part and removing the thereby coated member.

According to other features of the method:

the coating layer is a layer based on a lignocellulosic material, a lignocellulosic complex or a coating comprising a plurality of layers based on lignocellulosic material; and

the member to be coated is a part based on natural fibres.

Other aspects and advantages of the disclosure will become apparent upon reading the description which follows, given as an example, and made with reference to the appended drawing, wherein:

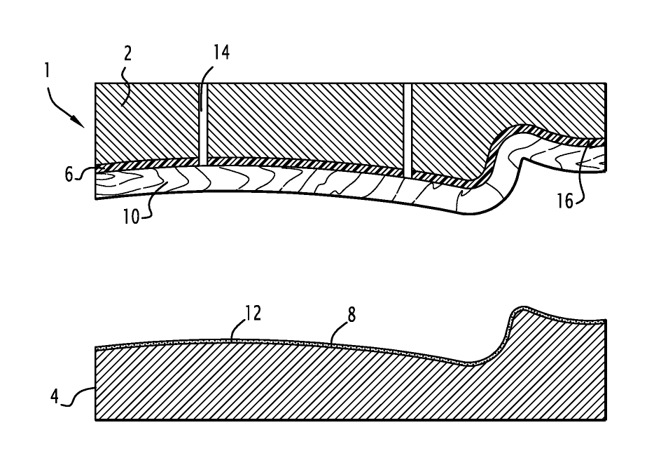

FIG. 1 is a schematic sectional illustration of a compression mould according to the disclosure, in which a member to be coated and a coating layer are positioned.

With reference to FIG. 1, a compression mould 1 is described, comprising a male part 2 and a female part 4 each comprising a reception surface 6 and 8 of a three-dimensional member 10 and of a coating layer 12 respectively.

The reception surfaces 6 and 8 have the three-dimensional shape of the member 10 and are positioned facing each other.

The male part 2 is movable towards the female part in order to press the member 10 and the coating layer 12 against each other and to bind them in order to obtain at the mould outlet a member coated with the coating layer 12.

The male part 2 comprises means 14 for forming a vacuum on its reception surface 6 enabling the member 10 to be maintained against this surface. These means for example comprise suction channels crossing the male part 2 and allowing the member 10 to be sucked up against the reception surface 6.

The coating layer 12 is maintained against the reception surface 8 of the female part for example by attachment means of the hook, clip type, etc. The coating layer which is flexible, is shaped by the reception surface 8, i.e. it adopts the shape of this reception surface and therefore that of the member 10 to be coated when it is positioned on the reception surface 8.

According to an embodiment, the mould comprises means (not shown) for heating at least one of the parts of the mould so as to coat the member by thermocompression. These heating means generally allow the female part 4 of the mould to be heated, the reception surface of which is closer to the contact face between the member 10 and the coating layer 12, in order to bind this member and this layer by thermocompression. The heating temperatures of the female part are for example greater than 90° C., and in particular greater than 130° C.

The male part 2 of the mould 1 comprises on its reception surface 6 a resin-based coating 16 attached onto the surface and against which the back face of the member 10 to be coated is positioned when the member 10 is placed in the mould.

With such a coating 16 it is possible to compensate for the geometrical instability of the member 10 and to apply uniform pressure on the whole of the member 10 during the compression. Poor positioning of the coating layer 12 relatively to the member 10 is thereby avoided and a member coated in a satisfactory way is obtained, which gives good quality to the part made.

The resin-based coating 16 for example comprises a thickness substantially comprised between 1 and 10 mm according to the calculated tolerances at each location of the reception surface 6.

The coating 16 for example has a hardness substantially comprised between 60 shore A and 100 shore A.

For a standard compression mould, i.e. a mould carrying out <<cold>> compression, the coating 16 for example is a polymer based on silicon or polyurethane withstanding temperatures greater than 30° C. and preferably greater than 40° C.

For a compression mould allowing thermocompression to be achieved, as described above, the coating 16 for example is a polymer based on silicon or polyurethane withstanding temperatures greater than 90° C., and preferably greater than 130° C.

In all the cases, the coating 16 withstands temperatures greater than the operating temperatures of the mould.

The coating 16 does not have any shape memory, i.e. it resumes its initial shape after each compression. Shape permanence of the reception surface 6 is thereby guaranteed for each compression.

The mould described above is used in a method for coating a member 10 with a coating layer 12.

During a preliminary step, the rigid member 10 is for example formed in a first compression mould in order to give it its three-dimensional shape. According to other examples, the rigid member 10 is formed by injection by means of an injection mould or further by extrusion.

The member 10 is then positioned on the reception surface 6 of the male part 2 and a coating layer 12 is positioned on the reception surface 8 of the female part.

The male part is brought closer to the female part in order to exert pressure on the member 10 and the coating layer 12 and to bind this member and this layer by compression or by thermocompression.

The male part is then moved away from the female part and the finished part is taken out of the mould.

Such a mould is particularly advantageous for a member 10 based on natural fibres. Indeed, the problem of three-dimensional stability is particularly posed for such a member. This problem is solved by the coating 16, as described above, with which it is possible to do without a foam layer positioned between the member and the coating layer. The obtained part thus retains its <<hard>> touch after it is coated with the coating layer. The natural fibres are for example wood or flax or another material or a mixture of different natural fibres.

It will also be understood that the mould and the method may be applied to any rigid member having problems of geometric stability.

The coating layer 12 is for example made on the basis of natural leather, of non-woven or woven textile, or on a lignocellulosic material, such as a wooden sheet or a lignocellulosic complex or a coating comprising a plurality of layers based on lignocellulosic material.

With the mould and the method described above it is possible to obtain a three-dimensional finished part, coated with a coating layer directly applied against the coated member and having a <<hard>> touch. The coating is produced in a satisfactory way and the quality of the finished part is guaranteed for the mould described above.

1. A compression mould for coating a rigid member with a coating layer, the mould comprising a male part and a female part each comprising a reception surface respectively of said member and of the coating layer, said surface having the shape of said member, one of the parts being movable so as to bear against the member and the coating layer so as to bind said coating layer to said member, characterized in that a resin-based coating is attached to one of the parts, said coating being intended to compensate for the geometrical instability of the member so as to apply a substantially uniform pressure on said member.

2. The compression mould according to claim 1, wherein the male part is movable towards the female part, the resin-based coating being attached to said male part.

3. The compression mould according to claim 1, wherein it comprises means for heating at least one of the parts of the mould so as to bind the coating layer to the member by thermocompression.

4. The compression mould according to claim 1, wherein the resin-based coating has a hardness substantially comprised between 60 shore A and 100 shore A.

5. The compression mould according to claim 1, wherein the resin-based coating is a polymer based on silicon or on polyurethane withstanding temperatures greater than or equal to 30° C.

6. The compression mould according to claim 5, wherein the resin-based coating withstands temperatures greater than or equal to 90° C.

7. The compression mould according to claim 1, wherein the resin-based coating has a thickness substantially comprised between 1 mm and 10 mm.

8. The compression mould according to claim 1, wherein the part to which the resin-based coating is attached, comprises means for forming a vacuum on the reception surface of said part in order to retain the member against said part.

9. A method for coating a rigid member by compression, using a compression mould according to claim 1, said method comprising the following steps:
positioning a coating layer and the member, each on a reception surface of the mould,
moving the movable part of the mould so that the resin-based coating uniformly bears against the member and the coating layer and the other part and binds the coating layer to the member,
moving the movable part so as to move it away from the other part and removing the thereby coated member.

10. The coating method according to claim 9, wherein the coating layer is a layer based on a lignocellulosic material, a lignocellulosic complex or a coating comprising a plurality of layers based on lignocellulosic materials.

11. The coating method according to claim 9, wherein the member to be coated is a part based on natural fibres.
